(19) United States
(12) Patent Application Publication
(10) Pub. No.: US 2004/0029608 A1
(43) Pub. Date: Feb. 12, 2004

(54) Mobile handset

(76) Inventors: Suzan Sachdeva, San Diego, CA (US); Kelly J. Davidson, San Diego, CA (US)

Correspondence Address: Kyocera Wireless Corp., Attn: Patent Department, PO Box 928289, San Diego, CA, 92192-8289, US

(21) Appl. No.: 10/185,953

(22) Filed: Jun. 27, 2002

(51) Int. Cl. H04M 1/00

(52) U.S. Cl. 455/550.1; 455/575.1

(57) ABSTRACT

The personalized mobile handset comprises a mobile handset with mounting parts on a face of the housing and mating accessories that can be detachably coupled to the mobile handset. In this way the mobile handset is personalized by the user. In another embodiment of the present invention the personalized mobile handset comprises a handheld device and a removable housing that is attached to the handheld device. In this embodiment mating accessories are detachably coupled to the removable housing. For example, a consumer interested in the sport of baseball may wish to transform their handheld device into a baseball player. In this case, the consumer could attach a head adorned with a baseball hat, two arms, and two legs to their handheld device to personalize it. However, if they are a fan of several sports, they have the flexibility to change the personalization of their handheld device to reflect a football player during football season, a basketball player during basketball season, and so on. Alternative personalities could be animals, action figures, comic book characters, landscapes. Additional possibilities will be apparent to one of skill in the art. The present invention has an advantage over handheld devices designed to permanently resemble a character, project an image, or reflect a concept.

### FIELD

The present invention relates generally to communications devices, and more particularly to mobile hand held communications devices.

### BACKGROUND

The evolution of mobile phones has resulted in new and expanding market opportunities. When introduced several years ago, mobile phones were bulky, heavy, and marketed primarily to business professionals. During this time, product offerings were limited and consumers had very few choices. As mobile phones became more common, they evolved from plain and utilitarian communications devices into attractive, handheld devices used to perform a variety of tasks. In addition to using it to place and receive phone calls, today's consumer expects a mobile phone to be a productivity tool and a source for entertainment that reflects their personal style.

The mobile handheld communications industry is competitive with manufacturers aggressively looking for new and innovative ways to distinguish their product offerings. In many cases individuals make purchasing decisions based solely on the appearance of the product. Many times these purchasing decisions are quick impulse purchases. For this reason it is important for manufacturers to market mobile handheld communications devices that attract attention and are distinguishable from the competition. In many cases the purchasing decision may be based on the buyers desire to have a mobile handheld communications device that is fun and different. Successful products in such a crowded market include elements of fun, style and uniqueness.

Nontraditional markets for mobile phones are emerging due to decreasing product costs and the convergence of devices. For example, teenagers are more likely now than ever before to influence or make a handheld device purchase. Instead of having task-specific devices, consumers have the choice to purchase one product capable of performing a number of tasks. Today's consumers, represented by diverse market segments, want innovative products that are refreshing, fun and easy to use, and reflect their individual life style.

Technological advances in the areas of hardware and software have also increased the ability of manufacturers to create mobile handsets that are fun and stylish. In terms of hardware, today's mobile phones often have color displays and easy-to-use navigation keys. In addition, mobile phone housings and accessories are available in many colors manufactured from a variety of materials. In terms of software, manufacturers have expanded the phone's functionality to include interactive games, stopwatch operations, text messaging functions, and more. These and other advances position mobile handheld communications devices for further customization and personalization.

### SUMMARY

An object of the invention is to gives consumers a quick and easy way to personalize their handheld communications device. The effect is a handheld device that is unique, attracts attention, is stylish, and imparts a sense of fun. This invention is possible today as a result of technological advances in the area of material properties, electronic components, and software development. As the properties of materials change, so does the opportunity to identify new and innovative ways to use the material. Today's materials last longer, are available in a wider range of colors and texture, and can be fabricated using a variety of methods.

As electronic components mature, they become smaller, lighter, and able to perform a greater number of functions. The proliferation of components helps to drive down production costs and gives manufacturers more flexibility when designing and building products. Advancements in software development complement the evolution of materials and components, which results in products with new features and functions.

The personalized mobile handset comprises a mobile handset with mounting parts on a face of the housing and mating accessories that can be detachably coupled to the mobile handset. In this way the mobile handset is personalized by the user. In another embodiment of the present invention the personalized mobile handset comprises a handheld device and a removable housing that is attached to the handheld device. In this embodiment mating accessories are detachably coupled to the removable housing. For example, a consumer interested in the sport of baseball may wish to transform their handheld device into a baseball player. In this case, the consumer could attach a head adorned with a baseball hat, two arms, and two legs to their handheld device to personalize it. However, if they are a fan of several sports, they have the flexibility to change the personalization of their handheld device to reflect a football player during football season, a basketball player during basketball season, and so on. Alternative personalities could be animals, action figures, comic book characters, landscapes. Additional possibilities will be apparent to one of skill in the art. The present invention has an advantage over handheld devices designed to permanently resemble a character, project an image, or reflect a concept.

### BRIEF DESCRIPTION OF THE DRAWINGS AND TABLES

For a more complete understanding of the present invention, and the advantages thereof, reference is now made to the following descriptions taken in conjunction with the accompanying drawings, tables and attachments, in which:

FIG. 1 is a diagram showing an embodiment of the present invention.

FIG. 2a is a diagram showing an embodiment of the present invention that uses an attachment track.

FIG. 2b is a diagram showing a side view of an embodiment of the present invention that uses an attachment track.

FIG. 2c is a diagram showing a side view of an embodiment of the present invention that uses an attachment track.

FIG. 3 is a diagram of an attachment track.

FIG. 4 is a diagram showing a personality part.

FIG. 5a is a diagram showing an embodiment of the present invention that uses snaps.

FIG. 5b is a diagram showing a side view of an embodiment of the present invention that uses snaps.

FIG. 5c is a diagram showing a side view of an embodiment of the present invention that uses snaps.

FIG. 6a is a diagram showing an embodiment of the present invention that uses hook and loop material.

FIG. 6b is a diagram showing a side view of an embodiment of the present invention that uses hook and loop material.

FIG. 6c is a diagram showing a side view of an embodiment of the present invention that uses hook and loop material.

FIG. 7a is a diagram showing a body part that uses a snap.

FIG. 7b is a diagram showing a body part that uses hook and loop material.

FIG. 8 is a diagram showing a plastic cover with snaps that attaches to a mobile handset.

### DETAILED DESCRIPTION

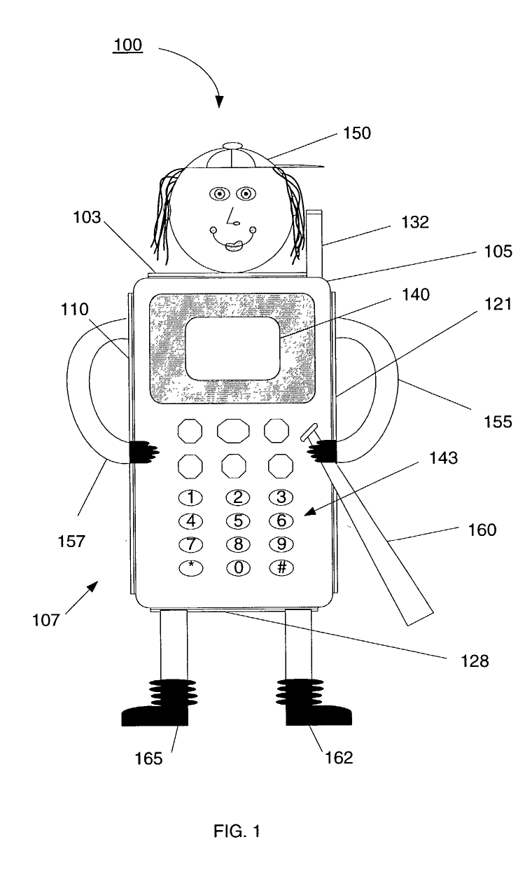

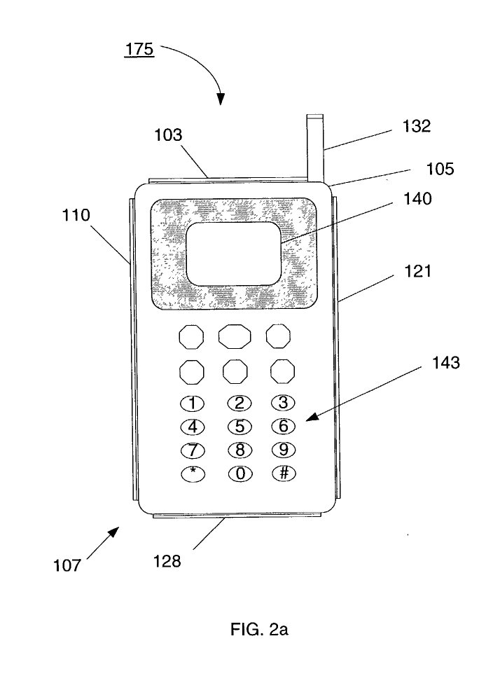

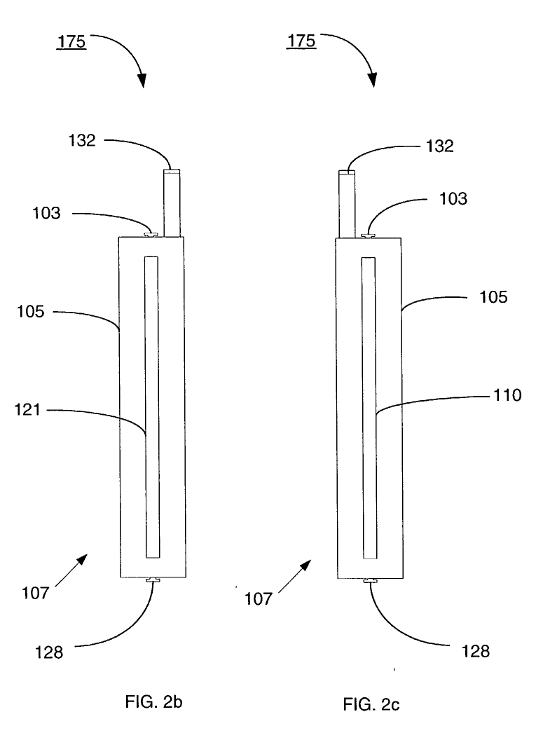

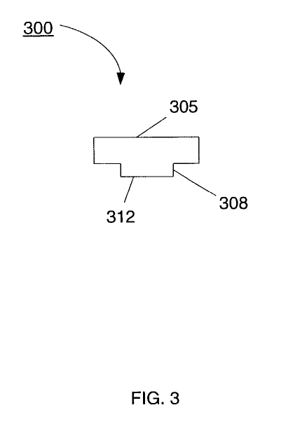

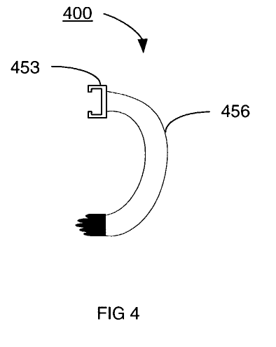

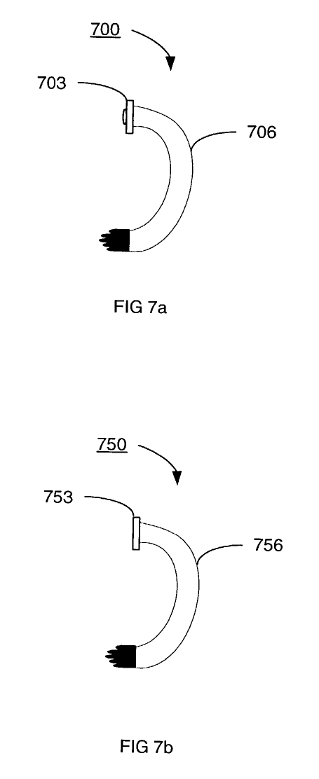

An embodiment of the present invention will now be described in detail with reference to the drawings. FIG. 1 is a diagram showing an embodiment of the present invention. The personalized mobile handset 100 in this example is designed to resemble a baseball player. The personalized mobile handset 100 consists of a mobile handset 107 with mounting parts attached to four faces on the housing 105. In FIG. 1 the mounting parts shown are attachment tracks 103, 110, 121, 128. Attachment tracks will be discussed further with respect to FIGS. 2a, 2b, 2c and 3. Accessories are attached to the attachment tracks 103, 110, 121, 128 on the housing 105 of the mobile handset 107 using an attachment part on the accessory. Attachment parts will be discussed in more detail in FIGS. 4, 7a, and 7b. The accessories can be in the form of personality parts. In this embodiment the personality parts are in the form of body parts. The body parts include, but are not limited to: a head 150; left and right arms 155, 157; a bat 160; and left and right legs 162, 165. Together, these personality parts give the mobile handset 107 the appearance of a baseball player. The mobile handset 107 also includes an antenna 132, an output device in the form of a display 140, and an input device in the form of a keypad 143.

Other types of personality parts are contemplated within the scope of this disclosure. For example, the personality parts may form a likeness of an animated character, a music star, or a hobby item such as a race car. Further, although personalized mobile handset 175 allows attachment to four faces, it will be understood that more or fewer faces may have attachment tracks or other mounting parts.

FIG. 2a illustrates a personalized mobile handset 175 without personality parts. The personalized mobile handset 175 uses attachment track 103, 110, 121, 128. The attachment tracks 103, 110, 121, 128 are attached to the housing 105 of the mobile handset 107. Any personality parts that a user wants to add to the mobile handset 107 are slid or snapped onto the track. The antenna 132, display 140, and a keypad 143 shown in FIG. 2a are similar to those shown in FIG. 1. FIGS. 2b and 2c show side views of FIG. 2a.

FIG. 3 details one possible embodiment of the attachment track 103, 110, 121, 128 shown in FIGS. 1, 2a, 2b, and 2c. FIG. 3 shows a side view of the track 300. The track 300 attached to the mobile handset along the attachment track handset attachment side 312. When the track 300 is attached to the mobile handset a grove 308 is formed. Personality parts that are attached to the housing 105 of the mobile handset 107 of FIGS. 2a, 2b, and 2c have a corresponding structure that slides or snaps onto the grove 308 formed between the track 300 and the mobile handset 107, FIGS. 2a, 2b, and 2c. The attachment track outside 305 is the side away from the mobile handset 107.

FIG. 4 shows a personality part. The personality part 400 is in the form of a left arm 456. The left arm is attached to the housing 105 of the mobile handset 107 of FIGS. 1, 2a, 2b, and 2c by an attachment part in the form of a track 453 attached to the left arm 456.

The personality part may be constructed from any material compatible with the intended use. For example, the personality part may be made from a soft or rigid plastic, from fabric, or even from a metal material of course a combination of material may be used for particular purpose. In a particular use, the personality part may also include electrical parts such as a light emitting diode; that are powered by a battery integrally formed with the personality part. By providing an electrical personality part, light and sound can be used to further personalize a mobile handset.

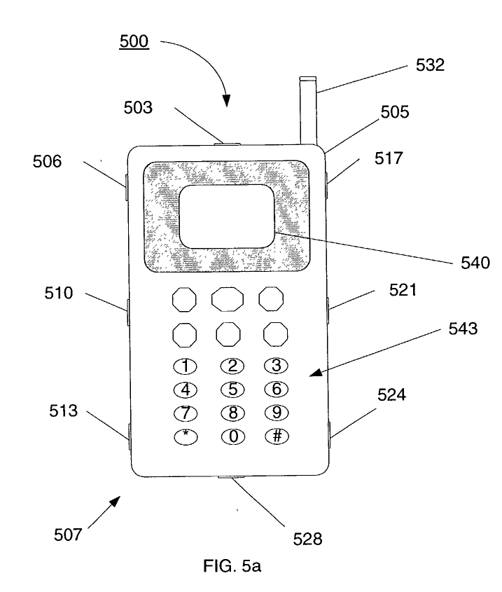

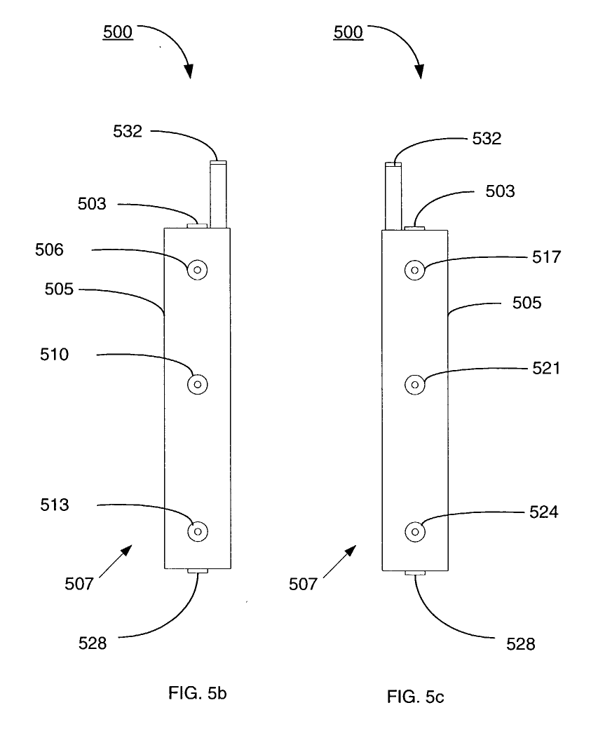

Another personalized mobile handset 500 is shown in FIG. 5a. The personalized mobile handset 500 has several snaps 503, 506, 510, 513, 517, 521, 524, 528 attached to the mobile handset 505. In addition to the snaps, the mobile handset 507 includes an antenna 532, a display 540, and a input device 543. The snaps are made up of two different parts. One part of the snap, the female part of the snap, is adapted to receive the other part of the snap, the male part of snap. If the housing 505 of the mobile handset 507 has the male part of the snap, then the personality part has the female part of the snap attached to it. The converse is also true. FIGS. 5b and 5c show side views of the mobile handset 505.

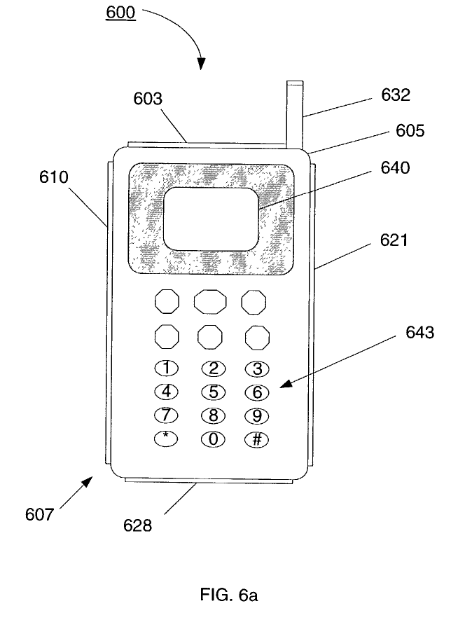

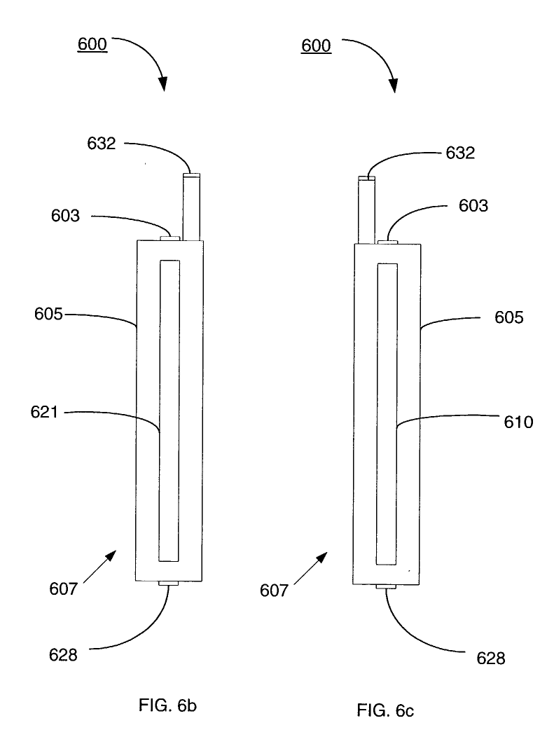

An embodiment of the invention will now be discussed with respect to FIG. 6a. The personalized mobile handset 600 comprises a mobile handset 607 with attachment devices in the form of hook and loop material 603, 610, 621, 628 attached to the housing 605. It will be apparent to one of skill in the art that if loop material is used as the attachment device for the mobile handset 607 then hook material is used a the attachment device on the personality part. The converse is also true. If hook material is used as the attachment device for the mobile handset 605 then loop material is used a the attachment device on the personality part. As also shown in FIG. 1, FIG. 6a also includes an antenna 632, a display 640, and a keypad 643. FIG. 6b and FIG. 6c shows side views of the personalized mobile handset 600.

Referring now to FIG. 7a a personality part 700 is shown in the form of a person's left arm 706. The form of a left arm 706 includes an attachment device in the form of a snap 703. FIG. 7b is similar to FIG. 7a. The personality part 750 is again in the form of a left arm 756, however the attachment part 753 is in the form of hook and loop material. It will be apparent to one of skill in the art that if hook material is used as the attachment part 753 on the personality part 700 then loop material 603, 610, 621, 628 is used as the attachment device on the mobile handset 607 of FIGS. 6a, 6b, and 6c. As discussed with respect with to FIG. 6a, the converse is also true.

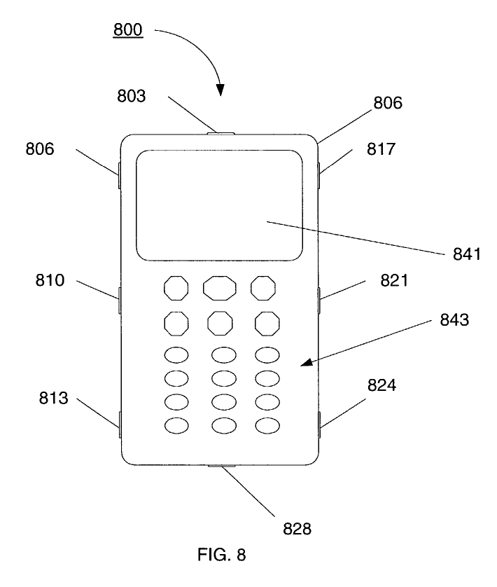

An embodiment of the present invention will now be discussed with respect to FIG. 8. FIG. 8 is a diagram showing a face plate with snaps 800. The faceplate 806 shown has eight snaps 803, 806, 810, 813, 817, 821, 824, 828 and can be attached to a mobile handset, not shown. The faceplate 806 also includes a display area 841 that is open to allow a user to view the display on a mobile handset. Similarly to the display area 841, a keypad area 843 is included to allow keys on the keypad of a mobile handset to be pushed while the plastic cover is installed on the mobile handset. It will be appreciated by one of skill in the art that the faceplate 806 can be attached to other portable wireless devices.

The description and drawings contained herein are particular embodiments of the invention and are representative of the subject matter broadly contemplated by the invention. However, the invention encompasses other embodiments that will be apparent to those skilled in the art. Accordingly, the scope of the invention is limited only by the appended claims.

What is claimed is:

1. A personalized mobile handset comprising:
a housing;
a mounting part on a face of the housing;
an accessory in the form of a personality part; and,
an attachment part on the accessory, the attachment part constructed to detachably couple with the mounting part; and wherein the accessory is detachably coupled to the housing using the attachment part and the mounting part.

2. A personalized mobile handset as in claim 1 wherein the personality part is in the form of a body part.

3. A personalized mobile handset as in claim 1 wherein the mounting part is a snap and the attachment part is a second snap adapted to couple with the first snap.

4. A personalized mobile handset as in claim 1 wherein the mounting part is hook material.

5. A personalized mobile handset as in claim 1 wherein the mounting part is loop material.

6. A personalized mobile handset as in claim 1 wherein the attachment part is hook material.

7. A personalized mobile handset as in claim 1 wherein the attachment part is loop material.

8. A personalized mobile handset as in claim 1 wherein the mounting part is an attachment track and the attachment part is a second attachment track adapted to couple with the first attachment track.

9. A personalized mobile handset comprising:
a housing;
a mounting part on the face of a housing;
an accessory in the form of a personality part;
an electric part attached to the personality part;
a battery coupled to the electric part and adapted to supply power to the electric part; and,
an attachment part on the accessory, the attachment part constructed to detachably couple to the housing using the attachment part and the mounting part,

10. A personalized mobile handset as in claim 9 wherein the electric part is a light emitting diode.

11. A personalized mobile handset as in claim 9 wherein the electric part is a speaker.

12. A personalized mobile handset comprising:
a housing; and
a mounting part on a face of the housing adapted to detachably coupled accessories to the housing;

13. A personalized mobile handset as in claim 12 wherein the mounting part is a snap.

14. A personalized mobile handset as in claim 12 wherein the mounting part is hook material.

15. A personalized mobile handset as in claim 12 wherein the mounting part is loop material.

16. A personalized mobile handset as in claim 12 wherein the mounting part is an attachment track.

17. A faceplate comprising:
a cover adapted to be attached to a portable wireless device;
a mounting part on a face of the housing;
an accessory in the form of a personality part; and,
an attachment part on the accessory, the attachment part constructed to detachably couple with the mounting part; and wherein the accessory is detachably coupled to the cover using the attachment part and the mounting part.

18. A faceplate as in claim 17 wherein the portable wireless device is a mobile handset.
